(19) United States
(12) Patent Application Publication
(10) Pub. No.: US 2026/0266112 A1
(43) Pub. Date: Sep. 10, 2026

(54) COOKING DEVICE LATCH SYSTEMS

(71) Applicant: SharkNinja Operating LLC, Needham, MA (US)

(72) Inventors: Heizai Liu, Shenzhen, Guangdong (CN); Matilda Swanson, London (GB); Edward Brown, London (GB)

(21) Appl. No.: 19/165,871

(22) PCT Filed: Mar. 17, 2023
(86) PCT No.: PCT/CN2023/082045

§ 371 Date: Sep. 16, 2025

(51) Int. Cl. E05C 19/02; A47J 37/06; E05C 19/14

(52) U.S. Cl. CPC E05C 19/02; A47J 37/0623; E05C 19/145

(57) ABSTRACT

A latch system for use with a cooking device and methods for latching a door are provided. In one embodiment, a cooking device is provided having a housing defining a cooking chamber, and a door rotatably coupled to the housing and having a catch. The latch system can include a rotor and biasing member disposed within the housing. The rotor can include a central hub rotatable about an axis of rotation, a tongue extending from the central hub, and a lever extending from the central hub opposite of the tongue. The biasing member can include a first end coupled to an end of the lever and a second end fixed to the housing. The projection can be configured to cause rotation of the rotor against a bias of the biasing member, causing the rotor to move through a first range of motion compressing the biasing member, and through a second range of motion decompressing the biasing member.

### FIELD

The present application generally relates to latch systems for cooking devices.

### BACKGROUND

Conventional cooking devices, such as pressure cookers and air fryers, each perform a single cooking operation, and as such, these devices employ different components and methods for cooking food items. As such, multiple devices are required to perform various cooking operations. For consumers that wish to enjoy food cooked in different ways via different operations, an accumulation of these devices can occur. For example, a consumer may have a steam cooker for cooking food while keeping it moist, and a separate air fryer to cook the food in order to achieve a desired level of crisp on the outer surface of the food. Such an accumulation of cooking devices is often prohibitive from a standpoint of cost and/or storage space.

Combination cookers, such as those that can perform both steaming and air frying operations, have been developed, however these devices often function best when the internal cooking environment is sealed. Such sealing can be performed by a seal around a door or opening and a latch or closure mechanism arranged to retain the door in a sealed configuration. Such a latch or closure mechanism should also be easily overridden by a user to allow the door to open once food preparation is completed.

For at least these reasons, improved cooking devices are needed.

### SUMMARY

A latch system and methods for latching a door are provided.

In one embodiment, a cooking device is provided having a housing defining a cooking chamber and a door coupled to the housing. The door is movable between open and closed positions. For example, the door can be rotatably coupled to the housing. The door can include a catch configured to interact with a latch system. The latch system can include a rotor having a central hub rotatable about an axis of rotation, and having a tongue extending from the central hub. The tongue can be configured to selectively engage the catch on the door. A lever can extend from the central hub opposite the tongue. The latch system can also include a biasing member having a first end coupled to an end of the lever and a second end fixed to the housing. During movement of the door between the open and closed positions, the catch can be configured to cause rotation of the rotor against a bias of the biasing member. This can cause the tongue to engage the catch and can cause the rotor to move through a first range of motion compressing the biasing member and through a second range of motion decompressing the biasing member. In other words, the rotor is configured to move from a first stable node point, through an unstable node point, and to a second stable node point

In some embodiments, the rotor includes a first arm extending from the central hub and a second arm extending from the central hub opposite the first arm. In some embodiments, the second arm includes a curved outer surface configured to selectively contact a switch positioned on the base.

Referring back to the tongue, in some embodiments, the tongue includes an end portion that extends parallel to the first arm. In other embodiments, a seal can be positioned between the door and the housing. In such embodiments, a compressive force on the seal can be maintained when the tongue is received within the catch when the door is in a closed position. Alternatively or in addition, the tongue can be configured to apply an opening assistive force to the projection when the door transitions from a closed position to an open position.

In some embodiments, the housing includes a stop positioned adjacent the rotor. The stop can include a first stop surface and a second stop surface. In some embodiments, the biasing member is configured to rotationally bias the rotor into contact with the first stop surface at an end of the first range of motion. Alternatively or in addition, the biasing member can be configured to rotationally bias the rotor into contact with the second stop surface at an end of the second range of motion. In some embodiments, an unstable node point is positioned between the first range of motion and the second range of motion. In such embodiments, the biasing member can be in a maximum compressed state at the unstable node point. Similarly, the biasing member can be in a decompressed state at the first stable node point and the second stable node point. In some embodiments, the rotor can be configured to contact a first stop surface of the housing at the first stable node point. Alternatively or in addition, the rotor can be configured to contact a second stop surface of the housing at the second stable node point.

In some embodiments a switch can be positioned within the housing. The switch can be configured to be contacted by a portion of the rotor with the door is in a closed position.

In some embodiments, a second rotor positioned within the housing, comprising a second central hub, a second tongue extending from the second central hub, and a second lever extending from the second central hub opposite of the second tongue. In some embodiments, the first rotor is axially displaced relative to the second rotor along the axis of rotation of the first rotor.

In one embodiment, a latch system is provided having a rotor arranged within the housing, and having a central hub rotatable about an axis of rotation, having a tongue extending from the central hub and having a lever extending from the central hub opposite the tongue. A catch can extend from a door rotatably coupled to the housing and include an aperture arranged therein. The aperture can be configured to selectively receive the tongue. A biasing member having a first end can be coupled to an end of the lever and can be configured to apply a biasing force to the lever such that the rotor can be configured to move from a first stable node point, through an unstable node point, to a second stable node point.

In some embodiments, the biasing member can be in a decompressed state at the first stable node point and the second stable node point. In some embodiments, the biasing member can be in a compressed state at unstable node point.

In some embodiments, the rotor can further include a first arm extending from the central hub and a second arm extending from the central hub opposite the first arm.

In some embodiments a switch can be positioned within the housing. The switch can be configured to be contacted by a portion of the rotor.

In some embodiments, the rotor can be configured to contact a first stop surface of the housing at the first stable node point. In some embodiments, the rotor can be configured to contact a second stop surface of the housing at the second stable node point.

In some embodiments, a second rotor positioned within the housing, comprising a second central hub, a second tongue extending from the second central hub, and a second lever extending from the second central hub opposite of the second tongue. In some embodiments, the first rotor is axially displaced relative to the second rotor along the axis of rotation of the first rotor.

In one embodiment, a latch system is provided having a rotor including a central hub rotatable about an axis of rotation, a tongue extending from the central hub, and a lever extending from the central hub opposite the tongue. A catch can extend from a body, the catch including an aperture arranged therein and configured to selectively receive the tongue. A biasing member can have a first end coupled to an end of the lever and configured to apply a biasing force to the lever such that the rotor is configured to move from a first stable node point, through an unstable node point, to a second stable node point.

### BRIEF DESCRIPTION OF THE DRAWINGS

These and other features will be more readily understood from the following detailed description taken in conjunction with the accompanying drawings, in which:

FIG. 1 is a schematic view of an embodiment of a cooking device;

FIG. 2A is a cross-sectional view of the cooking device of FIG. 1 taken along line 2-2 in FIG. 1;

FIG. 2B is a block diagram of a control system that can be used with the cooking device of FIG. 1;

FIG. 3 is a perspective view of the cooking device of FIG. 1 with a door open;

FIG. 4 is a perspective view of a portion of the cooking device of FIG. 1 with an outer housing removed to expose an upper latch system and a lower latch system;

FIG. 5A is a top view of a latch system of the cooking device of FIG. 1 with an upper housing removed;

FIG. 5B is a top view of a latch system of the cooking device of FIG. 1 with an upper housing removed;

FIG. 6A is a detailed top view of the latch system of FIG. 5A resting at a first stable node;

FIG. 6B is a detailed top view of the latch system of FIG. 6A positioned at an unstable node;

FIG. 6C is a detailed top view of the latch system of FIG. 6A resting at a second stable node;

FIG. 7A is a perspective cross-sectional view of an upper latch system within the housing of the cooking device of FIG. 1 taken along line 7A-7A in FIG. 1; and

FIG. 7B is a perspective cross-sectional view of a lower latch system within the housing of the cooking device of FIG. 1 taken along line 7B-7B in FIG. 1.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

A latch system is provided for use with a cooking device. Cooking devices having multiple cooking modes can require a door of the cooking device to be in a closed position to seal a cooking chamber of the cooking device. Such sealing can be performed by a seal around a door or opening and a latch or closure mechanism arranged to retain the door in the closed position, thereby compressing the seal. Such a latch or closure mechanism should also be easily overridden by a user to allow the door to open once food preparation is completed.

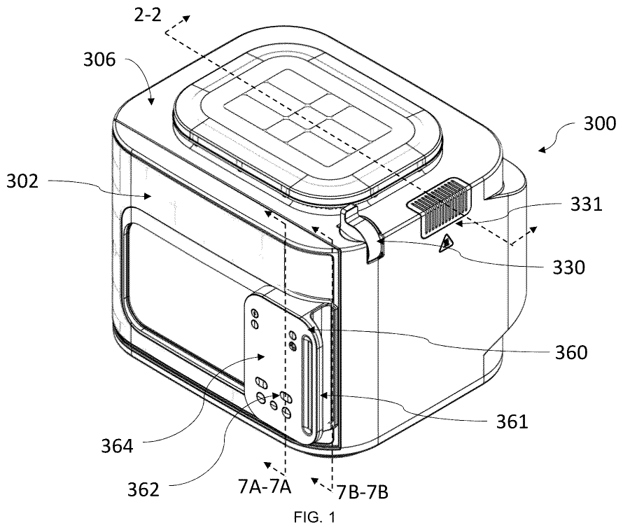

FIGS. 1-7 illustrate one exemplary embodiment of a cooking device 300 configured to perform multiple cooking operations and that can be used with the latch system disclosed herein. A person skilled in the art will appreciate that the latch system can, however, be incorporated into any cooking device or other device having a door that needs to be maintained in a sealed, closed position. The illustrated cooking device 300 is substantially similar to the cooking device disclosed in U.S. Pat. No. 11,490,761, entitled “Single Opening Vent For Steam Air Fryer” issued on Nov. 8, 2022, which is hereby incorporated by reference in its entirety. Major differences between the cooking device 300 and the cooking device disclosed in U.S. Pat. No. 11,490,761 include the latch system of the cooking device 300, described in detail below. As such, like components and operations between the two cooking devices are not described in detail.

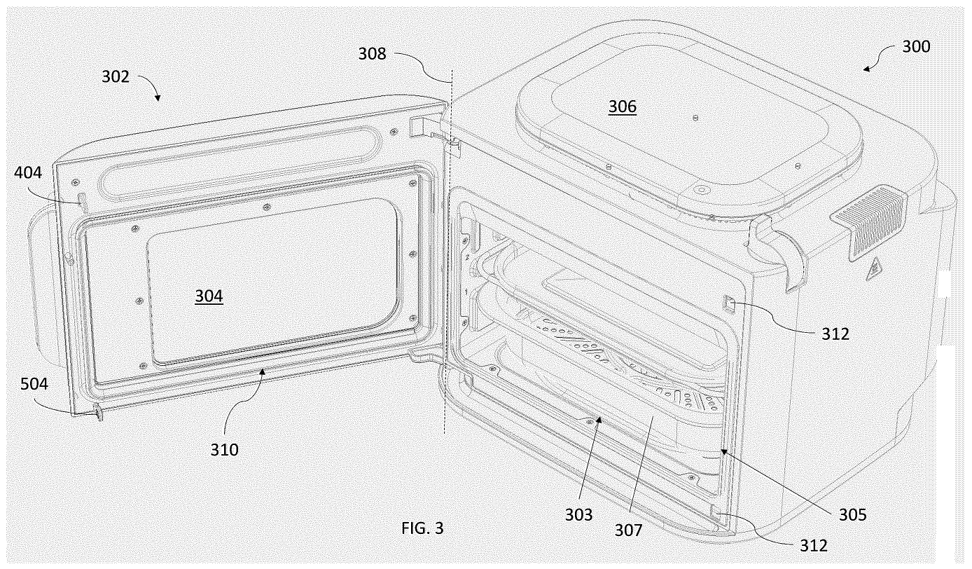

As shown, the cooking device 300 generally includes a door 302 and a housing 306, with the door 302 permanently or removably attached to the housing 306. In the illustrated embodiment, the door 302 is removably attached to the housing 306 with a connection or hinge area between the door 302 and the housing 306 occurring at a side portion of the housing 306 (shown in FIG. 3).

As depicted in FIG. 3, arranged inside of the housing 306 is a cooking compartment (also referred to herein as a “cooking chamber”) 303, which is accessible via an opening 305 arranged in the housing 306. In an exemplary embodiment, a container 307, such as a pot, tray, pan, sheet, etc., is receivable inside the cooking compartment 303. The container 307 can have an interior designed to receive and retain one or more consumable products, such as food products. Examples of food products suitable for use with the cooking device 300, include but are not limited to meats, fish, poultry, bread, rice, grains, pasta, vegetables, fruits, and dairy products, among others. The container 307 may be formed from any material suitable for use in a cooking environment, such as a ceramic, metal, or die cast aluminum material. In one embodiment, an interior surface of the container 307 includes a nano-ceramic coating. However, any suitable material capable of withstanding the high temperatures and pressures required for cooking consumable products is contemplated herein.

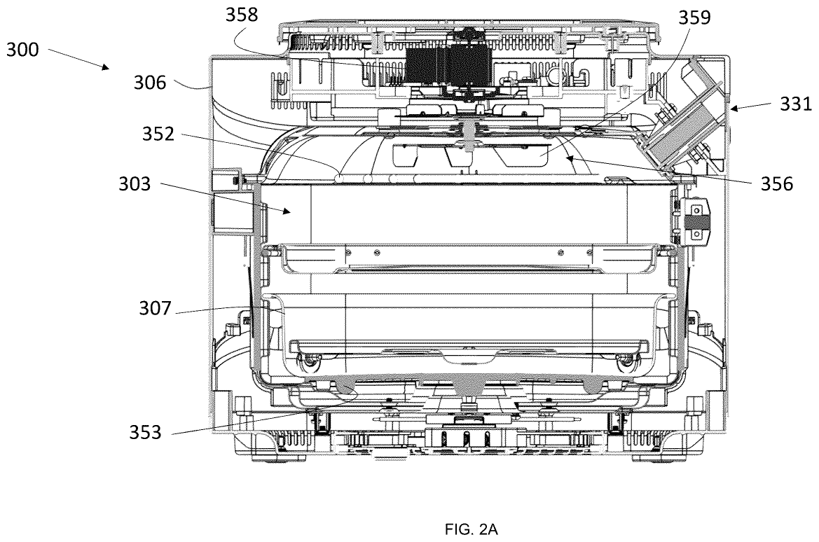

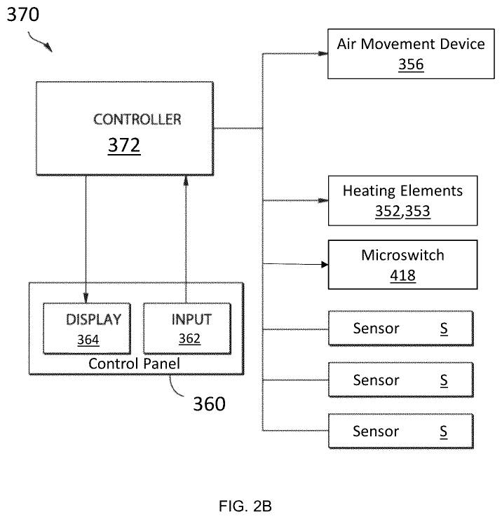

As depicted in FIG. 2A, the cooking device 300 can include one or more heating elements 352, 353 for heating the cooking compartment 303. In the illustrated device, a first heating element 352 is positioned generally at or above an upper extent of the cooking compartment 303 and therefore is completely outside of the area which the container 307 is inserted into the cooking compartment 303. A second heating element 353 is located generally adjacent a bottom of the cooking compartment 303 and can be completely outside of the area which the container 307 is inserted into the cooking compartment 303.

In the illustrated embodiment of FIG. 2A, an air movement device 356 is selectively operable to circulate a flow of fluid, for example air, through the cooking compartment 303. The air movement device 356 includes a motor 358 having a fan 359 coupled thereto. The air movement device 356 is operable to circulate air within the cooking compartment 303 through the at least one heating element 352. As the air passes over the at least one heating element 352, 353, the air is heated for cooking the consumable within the cooking compartment 303. In an exemplary embodiment, the air movement device 356 can be mounted within the upper portion of the cooking compartment 303 at a position vertically offset from the first heating element 352. However, other configurations of the air movement device 356 relative to the first heating element 352 are also contemplated herein, such as a concentric arrangement of the air movement device 356 and the first heating element 352.

As best shown in FIG. 1, a user interface or control panel 360 of the cooking device 300 is positioned on a handle 361 of the door 302, although the control panel 360 can be located elsewhere on the cooking device 300. The control panel 360 includes one or more inputs 362 associated with energizing the at least one heating element 352, 353 of the cooking device 300 and for selecting various modes of operation of the cooking device 300. One or more of the inputs 362 can include a light or other indicator to show that the respective input has been selected. The control panel 360 can additionally include a display 364 separate from and associated with the at least one input 362. However, embodiments where the display 364 is integrated into the at least one input 362 are also contemplated herein. Additionally, portions of the control panel 360 can be activated via the position of a switching mechanism 330.

The switching mechanism 330 is connected to a vent assembly 331, which is configured to control a flow of humid air from the housing 306. The switching mechanism 330 is configured to move the vent assembly 331 from an open position (for air-frying) to a closed position (for steaming). In order to achieve both a steam cooking operation and an air frying operation within the same unit, the high humidity air must be removed from the system and replaced with less humid air. By using a single vent assembly 331, the single vent assembly's inlet and outlet must be spaced apart to prevent the inlet taking in high humidity air from the outlet. The single vent assembly 331 is substantially similar to the single vent design disclosed in previously mentioned U.S. Pat. No. 11,490,761, which is hereby incorporated by reference.

When the vent assembly 331 is in a closed position, the display 364 is configured to be illuminated to inform a user that the cooking device 300 can be operated in a first cooking mode. A first portion of the display 364 is related to the first cooking mode, and can include options related to the first cooking mode, such as steaming, proofing, and steam and crisp processes. In some embodiments, this information is displayed in any of a variety of ways, with the illustrated display 364 having a first portion configured to show information related to the first cooking mode and a second, different portion of the display 364 configured to show information related to the second cooking mode, which may help a user easily discern that information is being shown in relation to a particular cooking mode based on where the information is shown on the display 364. When the vent assembly 331 is in an open position, the display 364 is configured to be illuminated to inform a user that the cooking device 300 can be operated in a second cooking mode. A second portion of the display 364 is related to the second cooking mode, and can include options related to the second cooking mode, such as air frying, baking, roasting, searing, and slow cooking processes. In an exemplary embodiment, the inputs 362 only function with the one of the first and second portions of the display 364 that is active due to the position of the switching mechanism 330.

FIG. 2B illustrates one exemplary embodiment of a control system 370 of the cooking device 300, which as shown includes a controller or controller 372 configured to control operation of the one or more heating elements 352, 353 and operation of the air movement device 356 (including the motor 358 and fan 359 associated therewith). In some embodiments, the control system 370 is additionally configured to execute stored sequences of heating operation. The controller 372 is configured to be operably coupled to the control panel 360, the one or more heating elements 352, 353, and the air movement device 356.

In addition, in some embodiments, one or more sensors S each configured to monitor one or more parameters (such as temperature, pressure, door open/closed configuration, etc.) associated with operation of the one or more heating elements 352, 353 can be arranged in communication with the controller 372. In one embodiment, a sensor S can be configured to monitor whether the door 302 is in a closed configuration. Alternatively, or in addition, a sensor S can be configured to monitor a temperature within the cooking compartment 303. Alternatively or in addition, a switch, such as a microswitch 418, can be configured to monitor a door open/closed status.

Accordingly, during a steam cooking operation, the controller 372 is configured to initiate operation of the one or more heating elements 352, 353, causing the temperature within the cooking compartment 303 to increase. This temperature increase would cause any fluid or moisture within the cooking compartment 303, either fluid directly arranged in the cooking compartment 303 or naturally embedded within the consumable located within the cooking compartment 303, to vaporize. With the air movement device 356 active, the fluid may become entrained within the air circulating through the cooking compartment 303. As a result, when the air and fluid is heated as it passes over the at least one heating element 352, 353, causing the fluid becomes a gas, such as water vapor or steam. This transformation of a liquid to a vapor performed within the cooking compartment 303 in response to the heat generated by the at least one heating element 352, 353 causes not only the pressure, but also the humidity, within the cooking compartment 303 to increase. This steam can then form condensation on the interior surface of the cooking compartment 303, including an interior surface 304 of the door 302.

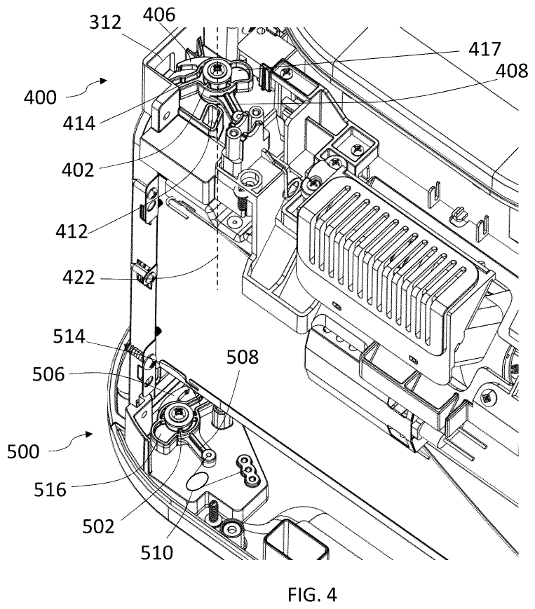

As shown in FIG. 3, the door 302 is configured to open along a vertical axis 308 to control access to the cooking compartment 303 through an opening 305 on a front side of the housing 306. The door 302 is arranged such that the interior surface 304 of the door 302 abuts the housing 306 when the door 302 in in the closed position. In some embodiments, the door 302 includes a portion of a latch, such as a catch or plates 404, 504, which can be used to lock the door 302 in the closed position. In such embodiments, the plates 404, 504 that extend from the door 302 on the side of the door 302 arranged to abut the housing 306 when the door 302 is in the closed position. In such embodiments, the housing 306 can define holes 312 arranged to receive the plates 404. 504 into the housing 306. Each plate 404, 504 can extend substantially parallel to an axis 422 of rotation of a rotor 402 (shown in FIG. 4), discussed further below. In some embodiments, each plate 404, 504 can include an aperture 405 arranged at an end of the plate 404. Additional latch components can be located within the housing 306. Examples of such components are described herein.

It should be noted that the door 302 is connectable to a front surface of the housing 306 to close off entry to the interior of the cooking compartment 303. Accordingly, when the door 302 is closed, the cooking compartment 303 can be defined by interior surfaces of the housing 306 and the interior surface 304 of the door 302. In an exemplary embodiment, an area of the door 302 can be complementary to an area of the housing 306 such that the door 302 covers the opening 305 of the housing 306. The door 302 can be made of any suitable material, such as glass, aluminum, plastic, or stainless steel. Further, the door 302 can, but need not, include one or more handles 361 for removably coupling the door 302 to the remainder of the cooking device 300.

Focusing on the door 302, a hinge at an end of the door 302 couples the door 302 to the housing 306. While the illustrated embodiment uses a hinge that is a vertical hinge that allows the door 302 to rotate about the vertical axis 308, other arrangements can be used without departing from this disclosure. For example, in some embodiments, a horizontal hinge can be used. For another example, in some embodiments, no hinge may be present at all and the door 302 can be removably attached to the housing 306 such as with one or more releasable latches. A seal 310 can be located between the door 302 and the housing 306. In some embodiments, the seal 310 is attached or otherwise fixed to the door. The seal can be configured to retain heat and moisture within the cooking compartment 303.

As previously indicated, a latch system is also provided for use with any cooking device, such as device 300. The latch system is configured to maintain the door in a closed position, thereby sealing the inner cooking chamber. FIG. 4 illustrates an exemplary embodiment of a latch system that includes an upper latch system 400 and the lower latch system 500. The upper latch system 400 and the lower latch system 500 are substantially identical with the exception of their location within the cooking device 300. Accordingly, our description of latch system 400 applies equally to latch system 500, and any other differences are described herein.

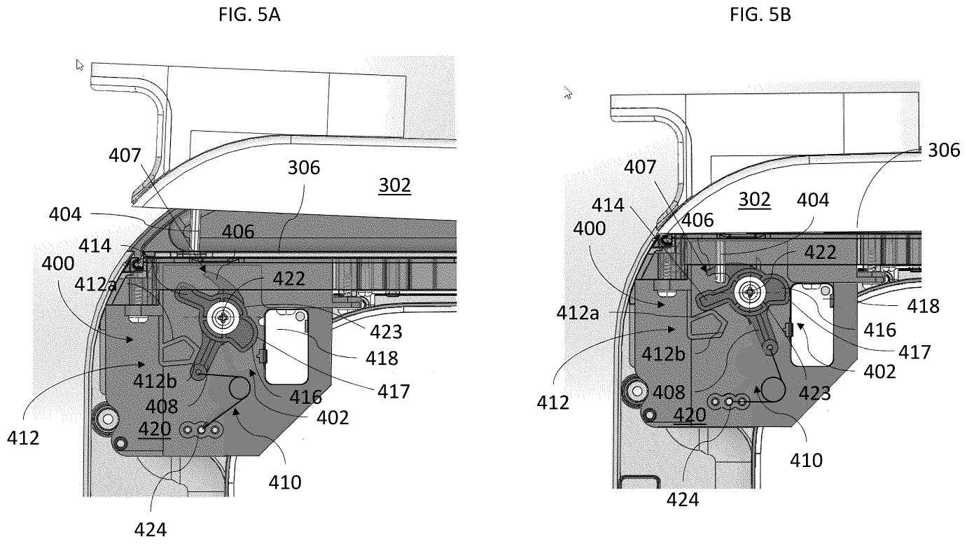

Focusing on the upper latch system 400 illustrated in FIG. 5A (open position) and FIG. 5B (closed position), the latch system 400 and related components can be mounted onto a base 420 within the housing 306. The latch system 400 includes a rotor 402 that is arranged to receive and interact with the catch or plate 404 extending from the door 302 towards the housing 306 when the door is in the closed position. The rotor 402 is configured to rotate relative to the base 420. In some embodiments, the axis 422 of rotation of the rotor 402 is perpendicular to the base 420 within standard manufacturing tolerances. In some embodiments, the rotor 402 is fastened to the base 420 by a fastener, for example, a bolt. Other fasteners, such as clips, can be used to rotatably secure the rotor 402 to the base without departing from this disclosure.

The illustrated rotor 402 includes four extensions. The first extension is a tongue 406 that extends outward from the central hub 423. The tongue 406 can include an end portion 407 arranged opposite the end connected to the central hub 423, and configured to interact with the plate 404. The tongue 406 can have an end that is eccentric relative the rotation axis 422. As illustrated in FIGS. 5A and 5B, the tongue 406 has a substantially hook-like shape, where the end portion 407 extends parallel to the first arm 414. The tongue 406 can be inserted through the aperture 405 when the plate 404 is within close proximity to the rotor 402.

Opposite from the tongue 406 is a lever 408 coupled to a biasing member 410. In some embodiments, the biasing member 410 can be in the form of a torsion spring. In such embodiments, a first end of the torsion spring is coupled to an outer end of the lever 408, and a second end of the torsion spring is coupled to a fixed point 424, such as a hole or other fixture defined by the base 420, within the housing 306. In some embodiment, a center of such a torsion spring can be fixed to the housing 306 as well. While primarily illustrated and described as a torsion spring, other biasing members can be used without departing from this disclosure. For example, in some embodiments, a compression spring, a tension spring, an air spring, or an elastic band can be used without departing from this disclosure. Regardless of the type of bias used, the biasing member 410 is arranged to interact with the lever 408 to bias the lever into two different low-energy positions. That is, the biasing member and lever act to produce a point of instability that biases the rotor to rotate clockwise or counterclockwise (as seen from the top view in FIGS. 5A and 5B) to an unlocked position (FIG. 5A) or a locked position (FIG. 5B). In some embodiments, one or more stops 412 can be included adjacent to the rotor to limit the rotor movement. In some embodiments, such stops 412 can be defined or be otherwise integrated with the base 420. More details on the stops 412 and their interaction with the rotor 402 are described later within this disclosure.

The rotor 402 also includes two arms, a first arm 414 and a second arm 416, extending from opposite sides of the rotor. In some embodiments, the first arm 414 and the second arm 416 are separated and distinct from the tongue 406 and the lever 408 while being arranged about the rotor 402. Additionally, the lever 408 and the first arm 414 can be arranged perpendicular to one another. In some embodiments, the first arm 414 is arranged to interfere with a stop surface 412a, for example, when the door 302 is in a shut position and the rotor 402 is in a locked position. In such embodiments, the first arm 414 is of sufficient length and at an angle to interfere with the stop surface 412a. In some embodiments, the second arm 416 includes a curved outer surface 417 arranged to interact with a switch or sensor to indicate a status of the rotor 402 and/or door 302. For example in some implementations, the second arm 416 can be arranged to depress a button of the microswitch 418. Such an interaction alters or produces a signal indicative of the rotor position. Such a signal can, in some embodiments, be interpreted by the controller 372 (FIG. 2B) to determine if the door 302 is in an open position (FIG. 5A) or a closed position (FIG. 5B). To perform such a function, the second arm 416 can include a rounded outer surface so as to smoothly depress and release the microswitch 418 based on the position and/or motion of the rotor 402.

In operation, when the door 302 is moving towards the closed position, the catch 404 impacts or is received by the rotor 402. More specifically, the plate 404 impacts the first arm 414, initiating a rotation in the rotor 402. Once the rotor has reached a point of instability, the biasing member 410 then continues the rotation of a rotor towards a stop surface 412a. During the rotation, the tongue 406 is inserted into a hole defined by the plate 404. Force is still applied to the lever 408 by the biasing member 410, causing the rotor 402 to apply a force to the plate 404 by the tongue 406 in the plate's original direction of travel towards a back-side of the cooking device 300. This force retains the door 302 to be substantially flush with the housing 306 (within standard manufacturing tolerances) and compresses the seal 310. That is, the latch system 400 and the plate 404 maintain a compressive force on the seal when the door 302 is in the closed position. In some embodiments, the second arm 416 of the rotor 402 engages with the microswitch 418. In such embodiments, the controller 372 can use the signal adjusted by the rotor engaging with the microswitch 418, to determine a state of the door. The state of the door can be used by the controller to enable or disable available cooking modes, for example, the controller 372 can enable a steam mode once the door 302 is determined to be in a closed state.

The rotation previously described can be ceased by a variety of components, for example, in some embodiments, the rotation is ceased by the first arm 414 impacting a first stop surface 412a. That is, the stop surface 412a interferes with first arm 414. In some embodiments, the rotation is ceased by the door 302 impacting the housing 306. In some implementations, the rotation is ceased due to the bias and rotor reaching a low-energy state. In such cases, stops 412 or dampers may be included to reduce ringing (oscillations).

In operation, when the door 302 is moving towards the open position, the plate is moved away from the rotor, for example, by a user pulling on the door 302. Such movement initiates rotation in the rotor 402 from the tongue 406. Once the rotor 402 has reached a point of instability, the biasing member 410 then continues the rotation of the rotor 402 towards a stop surface 412b. During this rotation, the tongue 406 is removed from the aperture 405 defined by the plate 404, releasing the compressive force on the seal 310. In some implementations, the first arm 414 impacts the plate 404, accelerating the plate 404, and therefore the door 302.

In some embodiments, such rotation is ceased by a variety of components. For example, in some embodiments, the rotation is ceased by the lever 408 impacting the stop surface 412b. That is, the stop surface 412b interferes with the lever 408. In some implementations, the rotation is ceased due to the biasing member 410 and rotor 402 reaching a low-energy state, where the spring is less compressed compared to a high-energy state. In such cases, stops 412 or dampers may be included to reduce ringing (oscillations). In some embodiments, the first stop surface 412a and the second stop surface 412b can be a same stop 412.

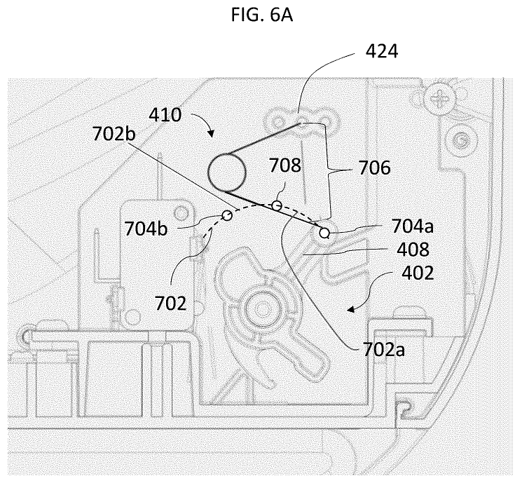

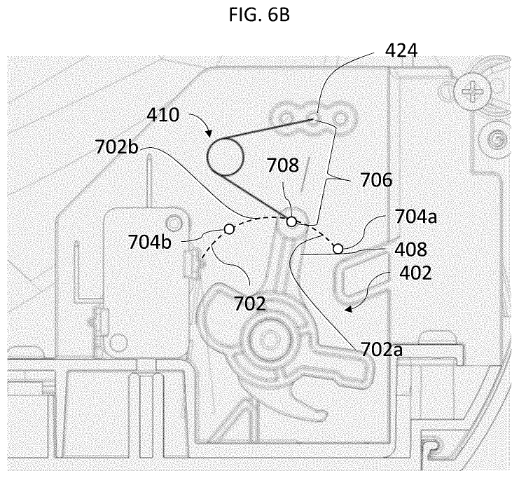

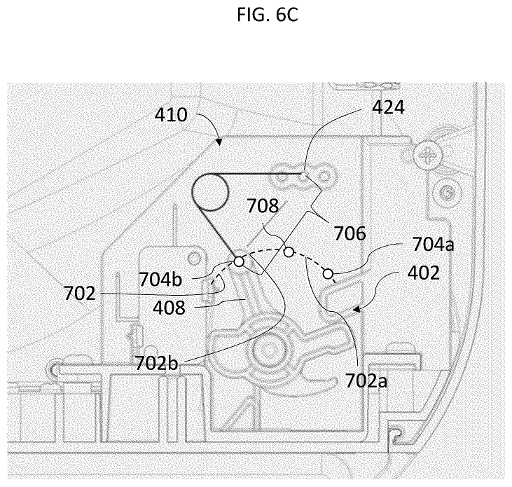

FIGS. 6A-6C illustrate biasing member 410 and rotor 402 moving through low (uncompressed) and high (compressed) energy states. There are three nodes across an arc 702 of travel for the rotor 402. The first node 704a, where an end of the lever 408 is located in FIG. 6A, is a low energy node where the biasing member 410 is uncompressed relative to a critical point in the form of an unstable node point, discussed in greater detail below. In this example, the rotor 402 is in the open position in FIG. 6A. That is, the first node is a position of stability and can be referred to as a stable node point 704a. In the illustrated implementation, the biasing member 410 is in the form of a torsion spring under compression. As the torsion spring is under compression, it is biased to expand, or increase a distance 706 between two ends of the spring. The first stable node point 704a is a position where the biasing member 410 can no longer expand. That is, distance 706 is as great as the rotor 402 will allow the distance to increase in a first direction of rotation. Moving to FIG. 6B, the lever 408 is positioned at a high-energy position, or an unstable node point 708. This is the position along the arc 702 at which the distance 706 is smallest along the arc 702. As such, the example torsion spring is experiencing maximum compression along the arc 702 at this unstable node point 708. As such, the spring is exerting force to expand, rotating the rotor 402 towards the stable node point 704a already described or a second stable node point 704b, where the lever 408 is shown resting with the rotor in the closed position in FIG. 6C. In operation, when a plate 404 is received (such as when the door 302 is closed), the rotor 402 moves through a first range of motion 702a, between the first stable node point 704a and the unstable node point 708, compressing the biasing member 410. Then the rotor 402 moves through a second range of motion 702b, between the unstable node point 708 and the stable node point 704b, decompressing the biasing member 410. The opposite motions can occur when the door 302 is opened.

As indicated above and illustrated in FIG. 4, the cooking device 300 can include a first, upper latch system 400 and a second, lower latch system 500, which are axial displaced from each other along the axis of rotation 422. Both latch systems 400, 500 are substantially similar with the exception of any differences described herein.

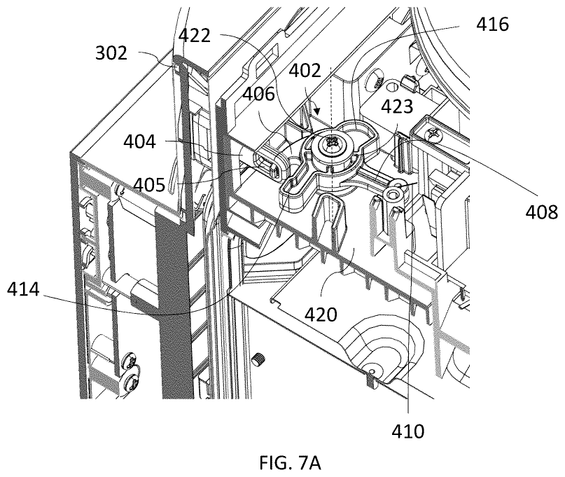

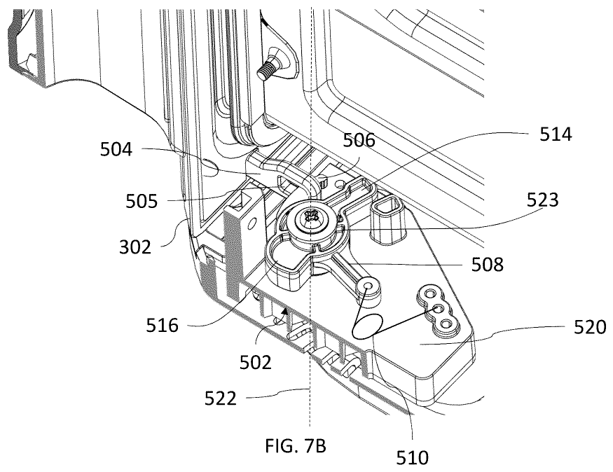

Referring to FIGS. 3, 7A, and 7B, a second plate 504 extends from the door into the housing 306 when the door 302 is in the closed position. The second plate 504 includes an aperture at an end of the second plate 504 away from the door 302. The first plate 404 is near an upper end of the door and the second rotor is near a lower end of the door. “Near” in this context means that the plates are closer to their respective ends than the opposite ends. The first rotor 402 is arranged to engage with the first plate 404 and the second rotor 502 arranged to engage with the second plate 504.

As illustrated in FIGS. 3 and 7B, a second rotor 502 is substantially identical to the first rotor 402. As such, the second rotor 502 includes a central hub 523 rotatable about a second axis 522 of rotation. In some embodiments, the first axis 422 of rotation and the second axis 522 of rotation are parallel to one another. In some embodiments, the first axis 422 of rotation and the second axis 522 of rotation are aligned with one another; however dimensions of the door 302, the first plate 404, the second plate 504, and position of the holes 312 can all impact the position and alignment of the first axis 422 and the second axis 522. That is, the first axis 422 and the second axis 522 can be miss-aligned, not parallel, or both, without departing from this disclosure. Additionally, the first rotor 402 can be axially displaced relative to the second rotor 502 along the axis 422 in a vertical direction.

The second rotor 502 includes a second tongue 506 extending from the second central hub, the second tongue 506 having a central axis offset from an axis of rotation of the rotor, wherein the second tongue 506 is configured to be selectively received within the aperture 505 of the second plate 504 connected to the door 302 of the cooking device 300 when the door 302 is in a closed position. Similarly, a second lever 508 extend from the second central hub opposite of the second tongue 506. A second bias 510 is coupled to the second rotor 502. In some embodiments, the second bias 510 substantially identical to the first biasing member 410; however, geometry restraints with in the housing can result in the use of a different shape or type of bias. The second bias 510 is coupled to the end the second lever 508. The second bias 510 arranged to bias the second rotor in a first position or a second position. A second base supports the second rotor 502 to the housing 306. The second rotor 502 is rotatable relative to the second base 520. The second rotor can also include a first arm 514 and a second arm 516 arranged on opposite sides of the central hub 523.

Certain exemplary implementations have been described to provide an overall understanding of the principles of the structure, function, manufacture, and use of the systems, devices, and methods disclosed herein. One or more examples of these implementations have been illustrated in the accompanying drawings. Those skilled in the art will understand that the systems, devices, and methods specifically described herein and illustrated in the accompanying drawings are non-limiting exemplary implementations and that the scope of the present invention is defined solely by the claims. The features illustrated or described in connection with one exemplary implementation may be combined with the features of other implementations. Such modifications and variations are intended to be included within the scope of the present invention. Further, in the present disclosure, like-named components of the implementations generally have similar features, and thus within a particular implementation each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described implementations. Accordingly, the present application is not to be limited by what has been particularly shown and described, except as indicated by the appended claims. All publications and references cited herein are expressly incorporated by reference in their entirety for all purposes.

What is claimed is:

1. A cooking device, comprising:
a housing defining a cooking chamber;
a door coupled to the housing and movable between open and closed positions, the door having a catch;
a rotor disposed within the housing and having a central hub rotatable about an axis of rotation, a tongue extending from the central hub, and a lever extending from the central hub opposite of the tongue; and
a biasing member disposed within the housing and including a first end coupled to an end of the lever and a second end fixed to the housing;
wherein, during movement of the door from the open to the closed position, the catch is configured to cause rotation of the rotor against a bias of the biasing member, thereby causing the tongue to engage the catch and causing the rotor to move through a first range of motion compressing the biasing member and through a second range of motion decompressing the biasing member.

2. The cooking device of claim 1, wherein the rotor further includes a first arm extending from the central hub and a second arm extending from the central hub opposite the first arm.

3. The cooking device of claim 2, wherein the second arm includes a curved outer surface configured to selectively contact a switch positioned on the base.

4. The cooking system of claim 1, wherein the tongue includes an end portion that extends parallel to the first arm.

5. The cooking device of claim 1, wherein the housing includes a stop positioned adjacent the rotor, the stop having a first stop surface and a second stop surface.

6. The cooking device of claim 5, wherein the biasing member is configured to rotationally bias the rotor into contact with the first stop surface at an end of the first range of motion.

7. The cooking device of claim 5, wherein the biasing member is configured to rotationally bias the rotor into contact with the second stop surface at an end of the second range of motion.

8. The cooking device of claim 1, wherein the biasing member has an unstable node point positioned between the first range of motion and the second range of motion.

9. The cooking device of claim 8, wherein the biasing member is in a maximum compressed state at the unstable node point.

10. A latch system, comprising:
a rotor arranged within a housing, the rotor including a central hub rotatable about an axis of rotation, a tongue extending from the central hub, and a lever extending from the central hub opposite the tongue;
a catch extending from a door rotatably coupled to the housing, the catch including an aperture arranged therein and configured to selectively receive the tongue; and
a biasing member having a first end coupled to an end of the lever and configured to apply a biasing force to the lever such that the rotor is configured to move from a first stable node point, through an unstable node point, to a second stable node point.

11. The latch system of claim 10, wherein the biasing member is in a decompressed state at the first stable node point and the second stable node point.

12. The latch system of claim 10, wherein the biasing member is in a compressed state at unstable node point.

13. The latch system of claim 10, wherein the rotor further includes a first arm extending from the central hub and a second arm extending from the central hub opposite the first arm.

14. The latch system of claim 10, further comprising a switch positioned within the housing and configured to be contacted by a portion of the rotor.

15. The latch system of claim 10, wherein the rotor is configured to contact a first stop surface of the housing at the first stable node point.

16. The latch system of claim 10, wherein the rotor is configured to contact a second stop surface of the housing at the second stable node point.

17. The latch system of claim 10, further comprising a second rotor positioned within the housing, the second rotor having a second central hub, a second tongue extending from the second central hub, and a second lever extending from the second central hub opposite of the second tongue.

18. The latch system of claim 17, wherein the first rotor is axially displaced within the housing relative to the second rotor along the axis of rotation of the first rotor.

19. A latch system, comprising:
a rotor including a central hub rotatable about an axis of rotation, a tongue extending from the central hub, and a lever extending from the central hub opposite the tongue;
a catch extending from a body, the catch including an aperture arranged therein and configured to selectively receive the tongue; and
a biasing member having a first end coupled to an end of the lever and configured to apply a biasing force to the lever such that the rotor is configured to move from a first stable node point, through an unstable node point, to a second stable node point.
